(19) United States
(12) Patent Application Publication
(10) Pub. No.: US 2010/0002337 A1
(43) Pub. Date: Jan. 7, 2010

(54) MAGNETIC RECORDING APPARATUS, RECORDING HEAD, AND MAGNETIC RECORDING METHOD

(75) Inventor: Hiroshi Uno, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/559,110

(22) Filed: Sep. 14, 2009

Related U.S. Application Data
(63) Continuation of application No. PCT/JP2007/058733, filed on Apr. 23, 2007.

(51) Int. Cl. G11B 5/17

(52) U.S. Cl. 360/123.01; G9B/5.104

(57) ABSTRACT

According to one embodiment, a magnetic recording apparatus includes a current modulator and a recording head. The current modulator modulates current according to codes with run-length limitation in which a run-length is limited to a predetermined number. The recording head moves relative to the surface of a magnetic recording medium where the information is recorded based on directions of magnetizations and forms the magnetizations by the modulated current. The recording head includes a coil and a magnetic core. The coil generates a magnetic field corresponding to the modulated current. The magnetic core extends inside the coil with an end facing the magnetic recording medium. The magnetic core forms the magnetizations by guiding and applying the magnetic field from the end to the magnetic recording medium. The length of the end in the direction in which the magnetizations are aligned is not less than a length of the predetermined number.

### CROSS-REFERENCE TO RELATED APPLICATIONS

This application is a continuation of PCT international application Ser. No. PCT/JP2007/058733 filed on Apr. 23, 2007 which designates the United States, incorporated herein by reference.

### BACKGROUND

1. Field

One embodiment of the invention relates to a magnetic recording apparatus that records information on a magnetic recording medium, a recording head, and a magnetic recording method for recording information on the magnetic recording apparatus.

2. Description of the Related Art

A magnetic recording medium has been widely used for recording information. On the surface of such a magnetic recording medium, magnetizations are aligned and information is recorded based on the magnetization directions. A magnetic recording apparatus that records information on the magnetic recording medium is provided with a recording head for forming magnetizations in directions according to information to be recorded on the magnetic recording medium. The recording head forms magnetizations by applying a magnetic field to the surface of the magnetic medium. In the recording head, the magnetic field is generated by causing electric current to flow through a coil wound around a predetermined magnetic core.

In recent years, an amount of information handled in a computer field or the like has been steadily increasing. With this, the information recording density of the magnetic recording medium has been sought to be increased. The information recorded on the magnetic recording medium is reproduced by detecting magnetic polarities of miniature magnetic fields generated by magnetic domains where magnetizations are formed on the surface of the magnetic recording medium, and recognizing respective magnetization directions. At this time, to increase the information recording density of the magnetic recording medium, coercivity Hc of the medium needs to be increased, and thus the magnetic field from the recording head needs to be increased.

It is common that new information is overwritten on a magnetic recording medium on which information has already been written. On such an occasion, a small amount of old information may remain when new information is overwritten. As an index indicating the rate of the remaining old information, an overwrite characteristic value is known. To maintain the overwrite characteristic value within a desired allowable range, information needs to be recorded with strong magnetic field.

As described above, the magnetic field applied from the recording head to the magnetic recording medium is generated by causing electric current to flow through a coil wound around a magnetic core, and the strength of the magnetic field depends on the amount of electric current flowing through the coil.

Therefore, to enhance the magnetic field applied to the magnetic recording medium, for example, electric current as large as possible may be caused to flow to enhance the magnetic field generated by the recording head. However, when the electric current is too high, the electric current causes heat or the like beyond an allowable amount for the circuit elements related to the current generation or the like, and thus there is a limit in increasing the electric current. Therefore, at the present time, to enhance the magnetic field applied to the magnetic recording medium, generally, the distance between the recording head and the magnetic recording medium is shortened as much as possible so that attenuation of the magnetic field from the recording head to the magnetic recording medium is suppressed instead of enhancing the magnetic field generated by the recording head. However, the enhancing of the magnetic field in this manner is also difficult because of a physical limit of shortening the distance between the recording head and the magnetic recording medium.

For example, Japanese Patent Application Publication (KOKAI) No. 2006-164312 discloses a conventional technology in which, upon forming magnetizations, a predetermined overshoot current is arbitrarily superimposed on the electric current flowing through the coil. With the conventional technology, new data is written by the overshoot of the electric current flowing through the coil, and old data having been recorded before the writing is deleted by electric current without overshoot. Since this overshoot current flows for a very short time, the magnetic field can be enhanced without a heavy load on the circuit elements.

With the conventional technology in which a magnetic field is enhanced by superimposing overshoot current, as the recording density increases, both the overshoot current and the electric current for deleting old data without overshoot need to be large. This increases especially heat stress on the circuit elements.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a hard disk drive (HDD) according to an embodiment of the invention;

FIG. 2 is an exemplary enlarged perspective view of a head gimbal assembly illustrated in FIG. 1;

FIG. 3 is an exemplary enlarged view of a magnetic head mounted on a end surface 201a illustrated in FIG. 2;

FIG. 4 is an exemplary enlarged view of a main magnetic pole illustrated in FIG. 3;

FIG. 5 is an exemplary flowchart of information recording on a magnetic disk;

FIG. 6 is an exemplary block diagram of a recording current generation circuit used for recording current generation in a preamplifier 107 illustrated in FIG. 1 and a control circuit;

FIG. 7 is an exemplary block diagram of a write amplifier illustrated as one block in FIG. 6;

FIGS. 8A to 8E are exemplary time charts for explaining the recording current generation by using a data example representing information to be recorded;

FIG. 9 is an exemplary enlarged view of a waveform of recording current Iw; and

FIG. 10 is an exemplary view illustrating how codes are recorded by the recording current Iw.

### DETAILED DESCRIPTION

Various embodiments according to the invention will be described hereinafter with reference to the accompanying drawings. In general, according to one embodiment of the invention, a magnetic recording apparatus comprises a current modulator and a recording head. The current modulator is configured to modulate current according to codes with run-length limitation in which a run-length is limited to a predetermined upper limit number or less. The run-length corresponds to the number of sequential zeros in binary digits representing information in a binary format. The recording head is configured to move relative to the surface of a magnetic recording medium on which magnetizations are aligned and the information is recorded based on directions of the magnetizations, and form the magnetizations on the surface by the current modulated by the current modulator. The recording head includes a coil and a magnetic core. The coil is configured to receive the current modulated by the current modulator and generate a magnetic field corresponding to the current. The magnetic core extends through inside the coil with an end portion facing the magnetic recording medium. The magnetic core is configured to form the magnetizations by guiding the magnetic field generated by the coil and applying the magnetic field from the end portion to the magnetic recording medium. The length of the end portion in the direction in which the magnetizations are aligned is equal to or longer than a length corresponding to the upper limit number.

According to another embodiment of the invention, a recording head is configured to move relative to the surface of a magnetic recording medium on which magnetizations are aligned and information is recorded based on directions of the magnetizations, and form the magnetizations on the surface by an electric current modulated according to codes with run-length limitation in which a run-length is limited to a predetermined upper limit number or less. The run-length corresponds to the number of sequential zeros in binary digits representing the information in a binary format. The recording head comprises a coil and a magnetic core. The coil is configured to receive the current modulated by a current modulator and generate a magnetic field corresponding to the current. The magnetic core extends through inside the coil with an end portion facing the magnetic recording medium. The magnetic core is configured to form the magnetizations by guiding the magnetic field generated by the coil and applying the magnetic field from the end portion to the magnetic recording medium. The length of the end portion in the direction in which the magnetizations are aligned is equal to or longer than a length corresponding to the upper limit number.

According to still another embodiment of the invention, there is provided a magnetic recording method comprising: modulating, by a current modulator, current according to codes with run-length limitation in which a run-length is limited to a predetermined upper limit number or less, the run-length being the number of sequential zeros in binary digits representing information in a binary format; supplying the current modulated at the modulating to a recording head configured to move relative to the surface of a magnetic recording medium on which magnetizations are aligned and the information is recorded based on directions of the magnetizations; and forming, by the recording head, the magnetizations on the surface. The forming includes: receiving, by a coil, the current modulated at the modulating and generating a magnetic field corresponding to the current, and guiding, by a magnetic core extending through inside the coil with an end portion facing the magnetic recording medium, the magnetic field generated by the coil and applying the magnetic field from the end portion to the magnetic recording medium to form the magnetizations. The length of the end portion in the direction in which the magnetizations are aligned is equal to or longer than a length corresponding to the upper limit number.

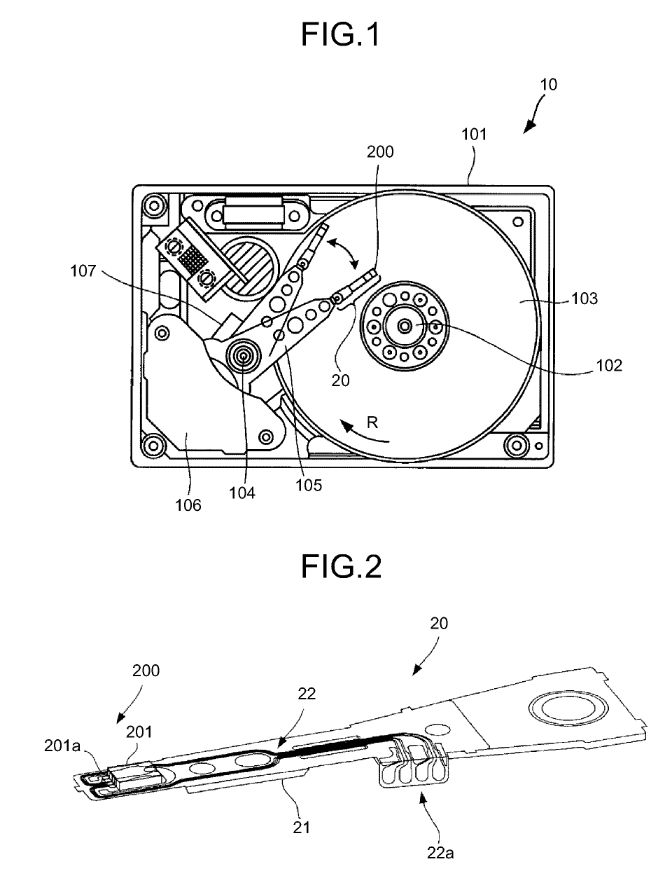

FIG. 1 is a diagram of a hard disk (HDD) 10 according to an embodiment of the invention.

As illustrated in FIG. 1, a housing 101 of the HDD 10 houses a magnetic disk 103 attached to a rotation shaft 102 to be rotated, a head gimbal assembly 20 having a head slider 200 obtained by mounting a magnetic head for recording/reproducing information to/from the magnetic disk 103 on a slider main body, a carriage arm 105 to which the head gimbal assembly 20 is fixed, the carriage arm 105 moving around an arm shaft 104 along the surface of the magnetic disk 103, an arm actuator 106 for driving the carriage arm 105, and a preamplifier 107 for controlling the magnetic head. The magnetic disk 103 will be described herein as an example of a magnetic recording medium of the embodiment.

In the embodiment, the magnetic disk 103 is a perpendicular magnetic recording medium corresponding to a perpendicular magnetic recording method in which information is recorded by forming magnetizations in a direction perpendicular to the surface of the magnetic disk 103. The magnetic head records and reproduces information by the perpendicular magnetic recording method.

The HDD 10 of the embodiment can record and reproduce data representing information in a general binary format without run-length limitation. When recording the data, an 8-bit binary data is converted to a 9-bit code with run-length limitation, in which the number of sequential “0s” (run-length) in the binary data representing information in a binary format is limited to three or less, as described below. The code with run-length limitation is recorded on the magnetic disk 103 by the recording head. To reproduce the information, the code with run-length limitation recorded on the magnetic disk 103 is read and the code with run-length limitation is reverse-converted into data represented in a general binary format.

In the embodiment, upon recording of binary numbers which makes up a code, the code with run-length limitation is recorded on the magnetic disk 103 according to the NRZI (Non Return to Zero Invert) method in which recording is performed by reversing the direction of magnetization every time “1” is found. To read the code with run-length limitation, sequential magnetizations in the same direction are converted to “0s”, and an inversion of magnetization is converted to “1”.

When recording information on the magnetic disk 103 and reproducing the data recorded on the magnetic disk 103, the carriage arm 105 is driven by the arm actuator 106 to position the magnetic head on the head slider 200 on a desired track on the rotating magnetic disk 103. As the magnetic disk 103 rotates, the magnetic head sequentially approaches positions each of which are to be magnetized and many of which are aligned in each track of the magnetic disk 103.

When recording the information, the data representing the information in a general binary format without run-length limitation and the data is converted to the codes with run-length limitation as described above in a control circuit (not illustrated). Thereafter, in the preamplifier 107, according to the codes with run-length limitation, electric current is modulated regarding an electric current value and positive/negative polarity of the electric current by using the NRZI method, so that a recording current carrying the codes with run-length limitation is generated. The generation of the recording current will be described in detail below.

The control circuit is mounted on a printed circuit board attached to the outside of the housing 101. The preamplifier 107 is mounted on the side surface of the root of the carriage arm 105.

The recording current generated by the preamplifier 107 is inputted into the magnetic head from the preamplifier 107. Then, a magnetic field whose polarity changes according to a positive/negative polarity change of the recording current is applied to the magnetic disk 103 by the magnetic head, and the codes with run-length limitation carried on the recording signal are recorded by the directions of magnetic domains according to the NRZI method. When reproducing the information, the magnetic head detects the magnetic polarities of the miniature magnetic fields generated from the respective magnetic domains, so that the magnetization directions of the respective magnetic domains are recognized, then sequential magnetizations in the same direction are converted to “0s”, and an inversion of magnetization is converted to “1” whereby the codes with run-length limitation are read.

FIG. 2 is an enlarged perspective view of the head gimbal assembly 20.

In FIG. 2, the head gimbal assembly 20 is illustrated in such a manner that the surface facing the magnetic disk 103 faces up.

The head gimbal assembly 20 comprises the head slider 200, a suspension 21 formed by a lengthy metal plate, and four leads 22. Two of the four leads are for recording information and the other two are for reproducing the information. The head slider 200 is mounted on the tip end of the suspension 21, and the leads 22 are wired on the suspension 21 and connected to the magnetic head included in the head slider 200. The head slider 200 comprises a slider main body 201 having a block shape, and the magnetic head is mounted on a end surface 201a of the slider main body 201.

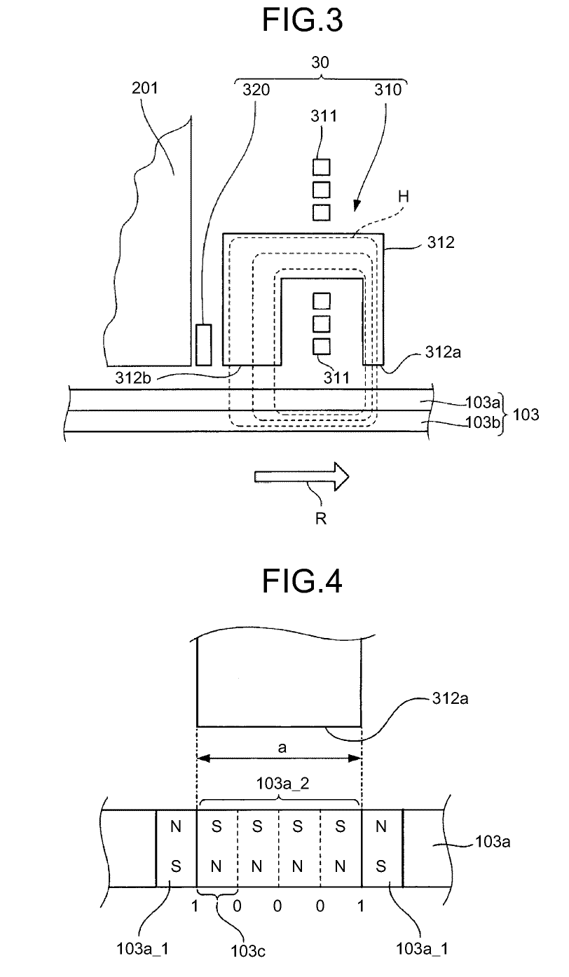

FIG. 3 is an enlarged view of the magnetic head mounted on the end surface 201a.

A magnetic head 30 mounted on the slider main body 201 comprises a recording head 310 for recording information by forming magnetizations corresponding to the codes with run-length limitation representing information to be recorded on the magnetic disk 103 and a reproducing head 320 for reproducing the information by detecting magnetic polarities of miniature magnetic fields on the magnetic disk 103 to read the codes with run-length limitation. Since the reproducing head 320 is known, a detailed description thereof is not provided here.

In the following, the recording head 310 will be described.

The recording head 310 comprises a coil 311 which receives the recording current and generates a magnetic field whose polarity changes according to a positive/negative polarity change of the recording current, and a magnetic core 312 which extends through the coil 311 to guide the magnetic field generated by the coil 311. FIG. 3 illustrates magnetic field lines H generated by the coil 311.

The magnetic field generated by the coil 311 and guided by the magnetic core 312 to be formed is a magnetic field in which a loop of the magnetic field lines H pass through the inside of the magnetic core 312, a magnetic layer 103a of the magnetic disk 103, and an underlayer 103b. Both ends of the magnetic core 312 form a main magnetic pole 312a and a sub magnetic pole 312b whose sizes are different from each other, and regarding the magnetic field is formed to have the magnetic flux density relatively large on the main magnetic pole 312a side, and the magnetic flux density relatively small on the sub magnetic pole 312b side. The center portion of the magnetic core 312 which connects the main magnetic pole 312a and the sub magnetic pole 312b passes through the inside of the coil 311.

As described above, information is recorded by the perpendicular magnetic recording method in the embodiment. The magnetic field lines H of the magnetic field pass through the magnetic layer 103a of the magnetic disk 103 in perpendicular direction, and magnetizations are formed in the magnetic layer 103a in the perpendicular direction. However, since the magnetic flux density of the magnetic field on the sub magnetic pole 312b side is smaller as described above, an effect of this magnetic field on the magnetization state of the magnetic disk 103 can be ignored, and magnetizations are formed on the main magnetic pole 312a side where the magnetic flux density is larger. At this time, magnetizations are formed according to the polarity of the magnetic field.

A description will be given of the length of the main magnetic pole 312a in the direction in which the magnetizations are aligned in the embodiment.

FIG. 4 is an enlarged view of the magnetic layer 103a.

FIG. 4 illustrates an example of a magnetization forming state in the magnetic layer 103a. In this example, in two magnetic domains 103a_1, magnetization having N polarity on the top surface side of the magnetic layer 103a is formed, while in one magnetic domain 103a_2, magnetization having S polarity on the top surface side is formed. Any size of magnetic domain can be physically formed in the magnetic layer 103a. However, since the recording density is fixed in the HDD 10, and the magnetic domain is notionally considered to be sequential domain units 103c having a size corresponding to the recording density. In the example of FIG. 4, the magnetic domain 103a_1 in which the magnetization having N polarity on the top surface side is formed includes one domain unit 103c, the magnetic domain 103a_2 in which the magnetization having S polarity on the top surface side is formed includes four domain units 103c.

As seen from FIG. 4, in the embodiment, the length a of the main magnetic pole 312a in the direction in which the magnetizations are aligned is four times the length of the domain unit 103c.

As described above, in the embodiment, information to be recorded is represented by codes with run-length limitation in which a run-length is limited to three (or less), and the codes with run-length limitation are recorded by the NRZI method.

FIG. 4 illustrates, as an example of the code with run-length limitation, a code in which three “0s” are sequentially aligned, i.e., a code corresponding to the maximum run-length in the embodiment. Since “0” is represented by sequential magnetizations in the same direction in the NRZI method, to record an alignment of three “0s” which corresponds to the maximum run-length, four domain units 103c are required as illustrated in FIG. 4. In other words, in the embodiment, the length a of the main magnetic pole 312a in the direction in which the magnetizations are aligned corresponds to the maximum run-length in the codes with run-length limitation. As a result, in the embodiment, by the magnetic field from the main magnetic pole 312a, magnetizations in the same direction are formed at the same time in the four domain units 103c. Such a formation of magnetizations is performed in each recording position while the recording position is changed along the track of the magnetic disk 103 as the magnetic disk 103 moves in the direction illustrated by an arrow R in FIGS. 1 and 3, so that the information is recorded.

Next, although there is some repetition, the recording of the information on the magnetic disk 103 performed in the HDD 10 will be described along with the process flow.

FIG. 5 is a flowchart of information recording on the magnetic disk 103.

The information recording illustrated in FIG. 5 will be described as the magnetic recording method of the embodiment.

This information recording starts when data representing the information in a general binary format without run-length limitation is inputted from an external apparatus (not illustrated) to the control circuit (not illustrated), and the magnetic disk is rotated.

First, in the control circuit (not illustrated) encoding is performed to convert the data into the codes with run-length limitation (S110). The preamplifier 107 then modulates electric current regarding the value and positive/negative polarity of the electric current by using the NRZI method according to the codes with run-length limitation obtained at S110 to generate the recording current (S120). The current modulation at S120 is an example of the current modulating process.

In the following, a schematic description will be given of a recording current generation circuit involve in the recording current generation from the encoding at S110 to the current modulation at S120 in the control circuit and the preamplifier 107. Then, the recording current generation will be described in detail using data examples representing the information to be recorded.

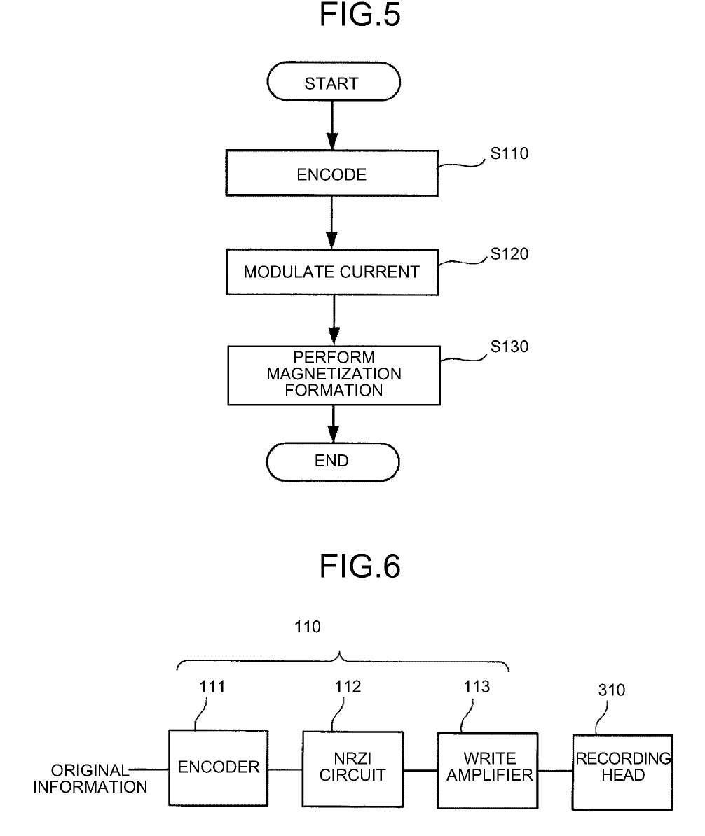

FIG. 6 is a block diagram of a recording current generation circuit 110 used for the recording current generation in the preamplifier 107 and the control circuit (not illustrated).

As illustrated in FIG. 6, the recording current generation circuit 110 comprises an encoder 111 for converting the data into the codes with run-length limitation, an NRZI circuit 112 for generating a differential-type NRZI signal to be described below based on the codes with run-length limitation obtained by the encoder 111, and a write amplifier 113 for modulating electric current based on the NRZI signal to generate the recording current and supplying the recording current to the coil 311 of the recording head 310. The encoder 111 serves as a converter, and a combination of the NRZI circuit 112 and the write amplifier 113 serves as a current modulator.

Described below is a circuit configuration of the write amplifier 113.

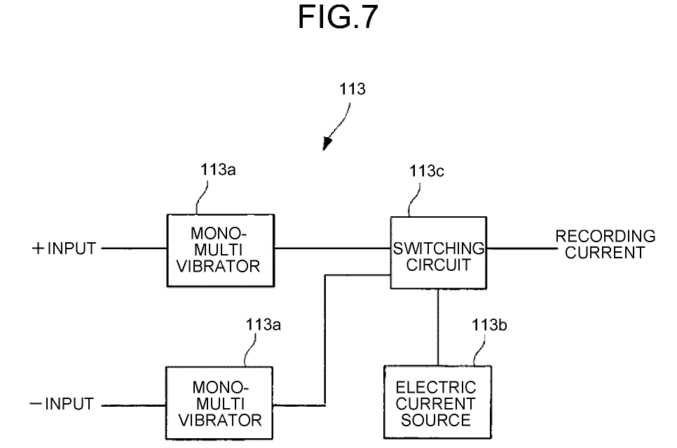

FIG. 7 is a block diagram of the write amplifier 113 illustrated as one block in FIG. 6.

The write amplifier 113 comprises two mono-multi vibrators for generating a pulse having a predetermined width when triggered by a rise of an input signal. To each of the two mono-multi vibrators 113a, two signals which are the differential-type NRZI signals generated in the NRZI circuit 112 are inputted respectively.

In addition, the write amplifier 113 comprises an electric current source 113b for outputting a positive polarity current which will be a source of the recording current, and a switching circuit 113c for performing modulation in which the electric current outputted from the electric current source 113b is flowed for a predetermined time as the polarity is switched based on the pulses generated in the respective two mono-multi vibrators 113a so as to generate the recording current.

The recording current generation circuit 110 used for the recording current generation is schematically configured as described above.

Next, the recording current generation performed in the recording current generation circuit 110 will be described by using a data example representing information to be recorded. In the description below, each of components illustrated in FIGS. 6 and 7 are referred to without specifying number of figures.

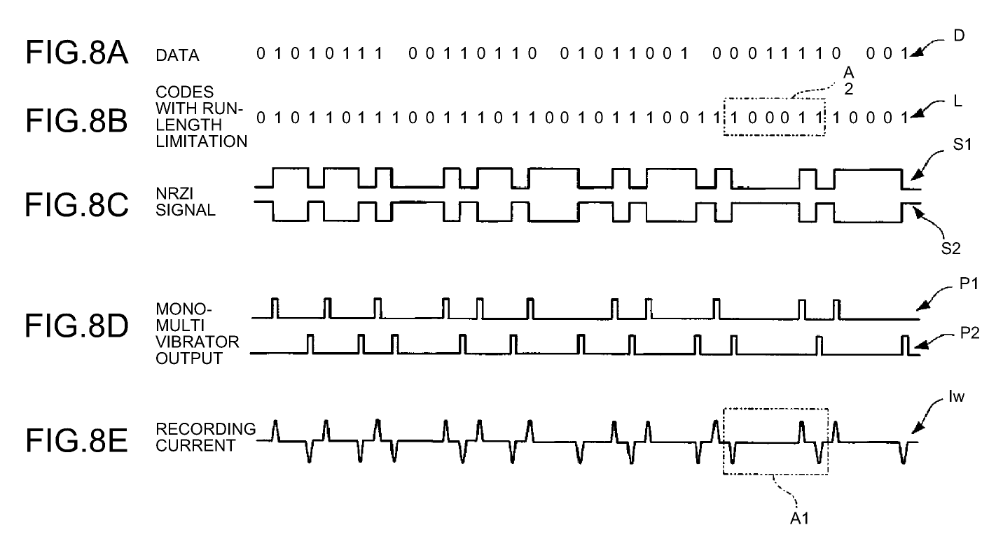

FIGS. 8A to 8E are time charts for explaining the recording current generation by using a data example representing information to be recorded.

FIG. 8A illustrates data D representing information in a general binary format without run-length limitation. FIG. 8B illustrates codes with run-length limitation L, in which the upper limit of the run-length is three, obtained by converting the data D. FIG. 8C illustrates two signals S1 and S2 which are the differential-type NRZI signals generated according to the run-length-limited codes L. FIG. 8D illustrates two pulse signals P1 and P2, i.e., pulses generated by the mono-multi vibrators 113a from the two signals S1 and S2, respectively. FIG. 8E illustrates the recording current Iw generated based on the two pulse signals.

The encoder 111 has a predetermined conversion code for converting eight bits in binary into nine bits in binary. Here, the conversion code is used for doubling the redundancy of information represented by the data by adding one bit to every eight bits, and rearranging the binary number in order not to generate four or more sequential “0s” by the conversion. The encoder 111 converts the data D illustrated in part (a) into the codes with run-length limitation L in which the run-length is limited to three or less illustrated in part (b) by the conversion using the conversion code without losing information represented by the original data D.

The NRZI circuit 112 generates the differential-type NRZI signals which are formed by the difference between the two signals S1 and S2 by shifting the levels of the two signals S1 and S2 into the opposite directions to each other in responding to “1” in the codes with run-length limitation L transmitted from the encoder 111.

The mono-multi vibrators 113a generate pulses having predetermined widths for the respective two signals S1 and S2 inputted into the respective mono-multi vibrators 113a from the NRZI circuit 112 when triggered by a rise of the signal. Thereafter, the pulse signals P1 and P2 including the generated pulses are outputted from the mono-multi vibrators 113a to the switching circuit 113c. Here, each pulse of the pulse signal P1 illustrated on the upper side of FIG. 8D and each pulse of the pulse signal P2 illustrated on the lower side of FIG. 8D alternately corresponds to “1” in the codes with run-length limitation L illustrated in FIG. 8B.

When a pulse of the pulse signal P1 illustrated on the upper side of FIG. 8D is inputted into the switching circuit 113c, the switching circuit 113c flows a positive polarity current supplied from the electric current source 113b for a time period corresponding to the pulse width of the pulse without polarity change, so as to generate a positive polarity pulse current having a width corresponding to the pulse width. Also when a pulse of the pulse signal P2 illustrated on the lower side is inputted, the switching circuit 113c switches polarity of the positive polarity current supplied from the electric current source 113b to negative polarity and flows the negative polarity current for a time period corresponding to the pulse width of the pulse, so as to generate a negative polarity pulse current having a width corresponding to the pulse width. The switching circuit 113c modulates electric current through such switching to generate the recording current Iw. Here, an amount of the electric current from the electric current source 113b is set in advance to an amount sufficient to complete a magnetization formation within a time period corresponding to a width of each pulse current of the recording current Iw. The waveform of each pulse current of the recording current Iw is an approximate triangle as illustrated in FIGS. 8A to 8E due to inductance and electrostatic capacity of the recording head 310.

Each pulse current of the recording current Iw generated through a series of processes described above is supplied to the coil 311 of the recording head 310 in a speed synchronized with the rotation speed of the magnetic disk 103 (see FIG. 1). Thereafter, as illustrated in FIG. 5, having received the pulse current, the recording head 310 (see FIG. 3) performs magnetization formation (S130).

Hereinafter, details of the magnetization formation at S130 will be described.

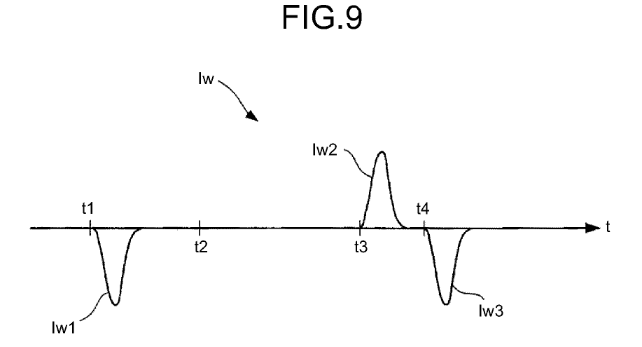

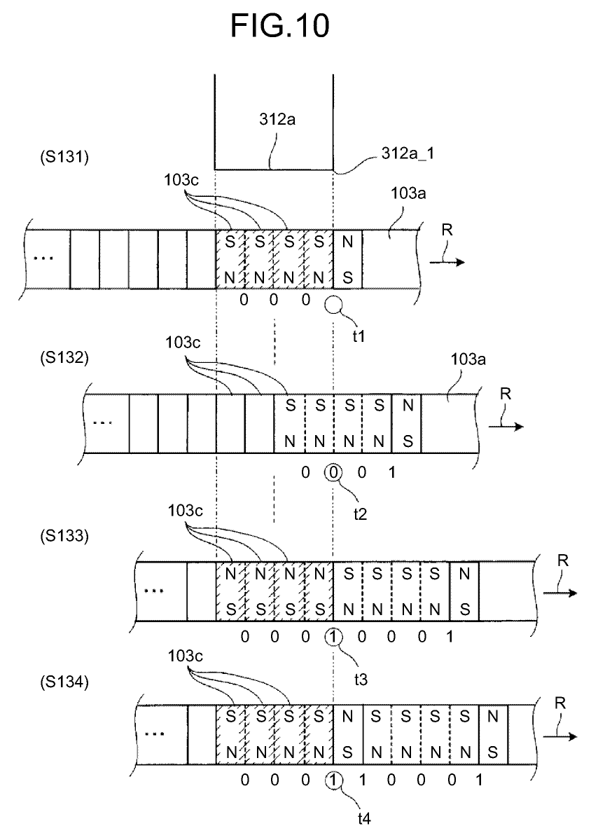

FIG. 9 is an enlarged view of the waveform of the recording current Iw, and FIG. 10 illustrates how codes are recorded by the recording current Iw.

FIG. 9 illustrates the three pulse currents Iw1, Iw2, and Iw3, whose positive/negative polarities are alternately inverted, in an area A1 enclosed by a two-dot chain line illustrated in FIG. 8E. Since each pulse current of the recording current Iw corresponds to “1” in the codes with run-length limitation L, each of the three pulse currents Iw1, Iw2, and Iw3 illustrated in FIG. 9 corresponds to three “1s” respectively in an area A2 enclosed by a two-dot chain line in FIG. 8B.

These three pulse currents Iw1, Iw2, and Iw3 are supplied sequentially from the Iw1 in the left to the coil 311 of the recording head 310 (see FIG. 3) along the time axis in FIG. 9, and a magnetization is formed at each time.

As described above, each pulse current is supplied to the coil 311 in a speed synchronized with the rotation speed of the magnetic disk 103 (see FIG. 1). In the examples in FIGS. 9 and 10, first, at the timing t1 when the tip end 312a_1 on the right side of the main magnetic pole 312a in FIG. 10 approaches the recording position where “1” will be recorded in the magnetic layer 103a moving in the direction indicated by the arrow R, the leftmost pulse current Iw1 in FIG. 9 is supplied to the coil 311. In the embodiment, a negative polarity pulse current corresponds to forming a magnetization having S polarity on the top surface side of the magnetic layer 103a, and at the timing t1, by supplying the negative polarity pulse current Iw1, magnetizations having S polarities on the surface side are formed simultaneously in four domain units 103c under the main magnetic pole 312a (S131).

By the magnetization formation at the timing t1, the leftmost “1” and three “0s” following the “1” in the area A2 in FIG. 8B are recorded at the same time. At the timing t2 when the tip end 312a_1 on the right side of the main magnetic pole 312a in FIG. 10 passes over the recording position where “0s” have already been recorded, the pulse current is not supplied, so that each domain unit 103c passes under the main magnetic pole 312a while the magnetization formation is not performed at the timing t2 (S132). Each domain unit 103c passes without magnetization formation as described above until the tip end 312a_1 approaches the recording position where next “1” will be recorded.

Thereafter, at the timing t3 when the tip end 312a_1 approaches the recording position where next “1” will be recorded, the second pulse current having the polarity opposite to the first pulse current Iw1 in FIG. 9 is supplied to the coil 311 (see FIG. 3). Then, magnetizations having N polarities on the surface side are simultaneously formed in the four domain units 103c under the main magnetic pole 312a (S133). By the magnetization formation at the timing t3, the second “1” following the first “1” and the three “0s” is recorded. By the magnetization formation at the timing t3 also, three “0s” following the second “1” are recorded.

The third “1” in the area A2 in FIG. 8B follows the second “1” recorded at the timing t3 in S133, and the pulse current Iw3 corresponding to the third “1” is supplied to the coil 311 at the timing t4 when the tip end 312a_1 approaches a recording position which is apart from the “1” recorded at the timing t3 by a distance corresponding to one domain unit 103c. As illustrated in FIG. 9, since the third pulse current Iw3 is a negative polarity pulse current opposite to the second pulse current Iw2, magnetizations having S polarities on the surface side are formed at the same time in four domain units 103c under the main magnetic pole 312a by supplying the third pulse current Iw3 (S134). In this way, following the timing t3 in S133, the third “1” and three “0s” following the third “1” are recorded.

In the magnetization formation process (S130) illustrated in FIG. 5, the recording of “1” and three “0s” following the “1” by supplying respective pulse currents of the recording currents Iw to the coil 311 (see FIG. 3) is continued until all the codes with run-length limitation L are recorded.

As described above referring to FIG. 4, in the embodiment, the length a of the main magnetic pole 312a in the direction in which the magnetizations are aligned corresponds to the maximum run-length. Therefore, in the embodiment, “0s” in the codes with run-length limitation can always be recorded along with “1” at the same time, so that a necessary recording current which should be supplied to the coil 311 is only the pulse current necessary for recording “1” as illustrated in FIGS. 8 and 9. As a result, the total amount of recording current necessary for recording all the codes with run-length limitation is significantly suppressed, and especially heat stress on the circuit elements such as the preamplifier 107 is significantly alleviated. There is an appropriate recording magnetic field for recording information on the magnetic disk 103. Therefore, according to the embodiment, stress on the circuit elements can be suppressed, and information can be successfully recorded on the magnetic disk 103.

Although the embodiment is described above as being applied to recording of information on the magnetic disk 103, this is by way of example and not of limitation. The embodiment may be applied to recording of information on any magnetic recording medium on which information is recorded by magnetization directions, such as, for example, magnetic tape.

Although codes with run-length limitation in which a run-length is limited to three are described above as an example of codes, the run-length limitation is not so limited. Codes with run-length limitation in which the upper limit of run-length is four or more may be similarly used.

Although the magnetic core 312 is described above as having a main magnetic pole whose length in the direction in which the magnetizations are aligned corresponds to the maximum run-length in the codes with run-length limitation, this is by way of example and not of limitation. The magnetic core may have a main magnetic pole whose length in the direction in which the magnetizations are aligned is longer than the maximum run-length in the codes with run-length limitation.

Although the current modulator is described above as generating a recording current only including the pulse current used for recording “1”, this is by way of example and not of limitation. The current modulator may generate a recording current including, in addition to the pulse current, an auxiliary current, which is weak enough not to cause excessive stress on the circuit elements, for assisting magnetization formation.

As set forth hereinabove, according to an embodiment of the invention, the number of sequential “0s” in the codes representing information is limited to a predetermined upper limit number or less. Since the length of the end portion is equal to or longer than the length corresponding to the upper limit number, magnetizations in an area corresponding to the upper limit number of sequential same numbers in the codes are reliably formed only by supplying electric current necessary for forming magnetization for one code to the coil. Accordingly, it is not necessary to supply electric current individually for each of a plurality of magnetizations corresponding to sequential “0s”, the total amount of electric current necessary for recording information can be suppressed, and especially heat stress on the circuit elements can be alleviated. That is, heat stress on the circuit elements can be suppressed, and information can be successfully recorded on the magnetic recording medium.

The recording head may be configured to form magnetization in a direction crossing the surface of the magnetic recording medium.

In such a perpendicular magnetic recording method, information is recorded by forming magnetization in a direction crossing the surface of the magnetic recording medium. There is an appropriate value regarding the recording magnetic field. It is independent from reproduction from the magnetic domains which are magnetized properly. In other words, upon recording, it is necessary to magnetize the magnetic domains properly.

A converter may obtain data representing information in a binary format without limitation of the number of sequential 0s and convert the data into codes.

Through the conversion by the converter, data represented in a general binary format can be handled.

In addition, the current modulator may perform modulation in such a manner that electric current is supplied to the coil only when information to be recorded is “1”.

With this, electric current supply is minimized, and especially heat stress on the circuit elements is further alleviated.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording apparatus, comprising:
a current modulator configured to modulate current according to codes with run-length limitation in which a run-length is limited to a predetermined upper limit number or less, the run-length being number of sequential zeros in binary digits representing information in a binary format; and
a recording head configured to move relative to a surface of a magnetic recording medium on which magnetizations are aligned and the information is recorded based on directions of the magnetizations, and form the magnetizations on the surface by the current modulated by the current modulator, wherein
the recording head includes
a coil configured to receive the current modulated by the current modulator and generate a magnetic field corresponding to the current, and
a magnetic core extending through inside the coil with an end portion facing the magnetic recording medium, the magnetic core configured to form the magnetizations by guiding the magnetic field generated by the coil and applying the magnetic field from the end portion to the magnetic recording medium, and a length of the end portion in a direction in which the magnetizations are aligned being equal to or longer than a length corresponding to the upper limit number.

2. The magnetic recording apparatus of claim 1, wherein the magnetic head is configured to form the magnetizations in a direction crossing the surface of the magnetic recording medium.

3. The magnetic recording apparatus of claim 1, further comprising a converter configured to obtain data representing the information in a binary format without limitation to the number of sequential zeros and convert the data into the codes.

4. The magnetic recording apparatus of claim 1, wherein the current modulator is configured to perform modulation such that the current is supplied to the coil only when magnetization in a first direction is formed next to magnetization in a second direction that has already been formed, the first direction being opposite the second direction.

5. A recording head configured to move relative to a surface of a magnetic recording medium on which magnetizations are aligned and information is recorded based on directions of the magnetizations, and form the magnetizations on the surface by an electric current modulated according to codes with run-length limitation in which a run-length is limited to a predetermined upper limit number or less, the run-length being number of sequential zeros in binary digits representing the information in a binary format, the recording head comprising:
a coil configured to receive the current modulated by a current modulator and generate a magnetic field corresponding to the current; and
a magnetic core extending through inside the coil with an end portion facing the magnetic recording medium, the magnetic core configured to form the magnetizations by guiding the magnetic field generated by the coil and applying the magnetic field from the end portion to the magnetic recording medium, and a length of the end portion in a direction in which the magnetizations are aligned being equal to or longer than a length corresponding to the upper limit number.

6. A magnetic recording method, comprising:
modulating, by a current modulator, current according to codes with run-length limitation in which a run-length is limited to a predetermined upper limit number or less, the run-length being number of sequential zeros in binary digits representing information in a binary format;
supplying the current modulated at the modulating to a recording head configured to move relative to a surface of a magnetic recording medium on which magnetizations are aligned and the information is recorded based on directions of the magnetizations; and
forming, by the recording head, the magnetizations on the surface, wherein
the forming includes
receiving, by a coil, the current modulated at the modulating and generating a magnetic field corresponding to the current, and
guiding, by a magnetic core extending through inside the coil with an end portion facing the magnetic recording medium, the magnetic field generated by the coil and applying the magnetic field from the end portion to the magnetic recording medium to form the magnetizations, a length of the end portion in a direction in which the magnetizations are aligned being equal to or longer than a length corresponding to the upper limit number.
